(19) United States
(12) Patent Application Publication
(10) Pub. No.: US 2014/0051116 A1
(43) Pub. Date: Feb. 20, 2014

(54) METHOD FOR CHARACTERISING THE ORIGIN AND/OR CONDITION OF DISEASED OR HEALTHY CELLS AND USES THEREOF IN BIOLOGY

(71) Applicants: Illa Tea, Nantes (FR); Estelle Martineau, Rouans (FR); Patrick Giraudeau, Nantes (FR); Serge Akoka, Orvault (FR); Sophie Nion, Nantes (FR)

(72) Inventors: Illa Tea, Nantes (FR); Estelle Martineau, Rouans (FR); Patrick Giraudeau, Nantes (FR); Serge Akoka, Orvault (FR); Sophie Nion, Nantes (FR)

(21) Appl. No.: 14/004,970

(22) PCT Filed: Mar. 12, 2012
(86) PCT No.: PCT/IB2012/051156

§ 371 Date: Oct. 23, 2013

(30) Foreign Application Priority Data
Mar. 14, 2011 (FR) 1152047

(51) Int. Cl. G01N 27/62

(52) U.S. Cl. CPC G01N 27/626
USPC 435/34; 436/63

(57) ABSTRACT

The invention relates to a method for characterising the origin and/or condition of diseased or healthy cells, characterised in that it includes the measurement of isotopic variations in a natural abundance of elements of cells, the contents of which are modified in a situation of disease, using an isotope-ratio mass spectrometer (abbreviated as IRMS), advantageously using an elemental analyser coupled with an isotope-ratio mass spectrometer (abbreviated as EA-IRMS).

The invention relates to a method for characterizing the origin and/or condition of diseased cells, in particular cancer cells, or of healthy cells. It also relates to the uses of this method in biology, comprising the health, diagnosis and research field.

The characterization of cells, in particular of cancerous tumors, is based mainly on the morphological diversity of the cells.

Other techniques, based on the molecular phenotype (DNA, RNA and proteins), such as DNA chips and protein chips, have been developed.

These techniques can assist with understanding the complex mechanisms of the disease since they make it possible to identify thousands of genes and proteins involved within a cell.

However, their implementation requires sample preparations and a very lengthy analysis of the results, which is not always discriminating for differentiating cells.

Furthermore, it is difficult to use them routinely because the results often need to be confirmed gene by gene or protein by protein using other techniques for validating molecular phenotypes which are the most common, such as quantitative Polymerase Chain Reaction (qPCR) after reverse transcription for gene expression profiles, and immunoblotting or immunocytochemistry/-histochemistry for proteins.

Such methods are often random, imprecise, lengthy to implement, fastidious and expensive.

The work of the inventors has therefore related to the search for a simple analytical method which makes it possible in particular to accurately differentiate cells, in particular cancerous tumors, to also differentiate the effects of a substance on diseased cells, in the context of a preclinical evaluation, and to obtain a rapid, inexpensive analysis which is easy to carry out in order to allow its routine laboratory use.

The results obtained have shown that the measurements of variations in the isotopic composition of certain elements of cells are clearly dependent on the isotopic effects associated with the biochemical processes and constitute an isotopic signature for characterizing a diseased cell, especially a cancerous cell, or by way of comparison a healthy cell.

The objective of the invention is therefore to provide a novel method for characterizing the origin and/or condition of diseased cells.

The invention is in particular directed toward the identification of healthy or diseased cells, in particular cancer cells, based on the measurement of variations in the isotopic composition of certain elements present in cells.

The invention is also directed toward providing means for studying the metabolic disruptions of these cells.

It also relates to the uses of this method for evaluating the effect of a therapeutic treatment and for producing databases.

The method according to the invention, for characterizing the origin and/or condition of diseased or healthy cells, is characterized in that it comprises the measurement of natural abundance isotope variations of elements of cells, or of cell extracts, the contents of which are modified in a diseased situation, the measurement of ¹⁵N and ¹³C isotope variations using an isotope-ratio mass spectrometer (abbreviated as IRMS), advantageously using an elemental analyzer coupled to an isotope-ratio mass spectrometer (abbreviated as EA-IRMS).

The term “cell extract” is intended to mean lyophilized cells and/or fractions of these cells.

In one preferred embodiment of the invention, the isotope variations measured are those of ¹⁵N and ¹³C.

The isotopic contents of these elements are specially expressed by the isotope ratio R of the ion currents of the fraction of the heaviest isotope to the lightest isotope. This involves quite particularly the ¹⁵N/¹⁴N and ¹³C/¹²C isotope ratios.

According to an additional provision, the natural abundance isotope variations of ²H and/or of ¹⁸O and/or of ³⁴S are also measured.

These various measurements make it possible to rapidly obtain, most generally in only about ten minutes, an isotopic fingerprint or signature for each cell type studied.

In one preferred embodiment of the invention, the method above is characterized in that it comprises at least one of the following steps:
introduction of the cell extracts with a stream containing oxygen into the combustion furnace of an EA-IRMS for the purposes of oxidation and/or reduction for the quantitative conversion of the cells into gas,
removal of the water formed and separation of the gases,
introduction of the gases into the IRMS in order to introduce molecular ions collected in collectors,
establishment of the spectra of the ion currents of the isotopomers of the isotopic elements to be measured,
the isotopic content of the cells studied being expressed by the isotope ratio R of the ion currents of the fraction of the heaviest isotope to the lightest isotope, and, if desired,
the comparison of the values obtained with that of a reference gas being expressed in delta per thousand.

Advantageously, the method of the invention also comprises the introduction of the cell extracts into a gas chromatograph in order to separate the molecules, and then into a combustion and reduction furnace for the quantitative conversion of the cells into gas, and then, after the removal of the water, the introduction of the gases into the IRMS as indicated above.

The above provisions, in part or in their entirety, are applied to a cell fraction, in particular a protein fraction, or to amino acids and/or to polar metabolites which may be intracellular or extracellular, or, according to another variant, to lipids extracted from cells.

The material studied is made up of cells originating from a tissue or from a biological medium, such as blood or urine, or of cells of a cell line.

Said cells are diseased cells, i.e. cells originating from any type of disease, in particular cancer cells. They may also be healthy cells, which allows comparisons to be made.

It is thus possible to have an isotopic fingerprint specific to each tumor, which can serve as a biomarker, and which can make it possible to accurately differentiate tumor cells and diseased cells and to evaluate the effects of a therapeutic action on these cells, in the context of a preclinical evaluation.

The ease with which the method of the invention is carried out, the rapidity with which it is carried out and its low cost constitute advantages for routine use.

There are numerous uses for this method. Among the sectors concerned, mention will be made of:
the sectors of researching biology, biochemistry at the cell or tissue level (characterization of cells and tissues, study of metabolic pathways, connections between the isotopic fingerprint and the cancer cell process),
the industrial sectors of pharmacy (evaluation of the therapeutic effect of a substance on a patient),
the health sectors (adapted medical diagnosis, patient follow up).

The method of the invention has numerous advantages in terms of performance levels, since the measurement is reproducible and insensitive to biological variation (identical measurements for cells which have divided several times: up to 48 cell divisions). The measurement can be easily compared with other laboratories, given that the isotopic deviation is a relative measurement which is always compared with an international reference. Thus, laboratories which have an EA-IRMS are capable of obtaining a unique signature.

The cost of the analysis is derisory, unlike biochips, since the sample preparation and the analysis are very simple. It is sufficient to recover a cell, tissue, blood or urine dry extract or a dry extract of other biological fluids, and then to introduce it into the EA-IRMS.

On the other hand, in the case of biochips, steps of extraction and of purification of the mRNA and of the proteins of the sample are necessary. The mRNA is then converted into cDNA by reverse transcription. The cDNA extracts or protein extracts are then labeled with a fluorochrome of different colors. All these complex sample preparation steps are sources of error for the analysis. The preparation of the biochips is also lengthy and fastidious, since it consists in immobilizing, on a solid support, probes (DNA or antibodies in the case of proteins) of which the role is to detect the complementary targets present in the mixture to be analyzed (cDNA or proteins). The results are obtained after high-resolution image analysis which makes it possible to detect the genes or the proteins of which the level is modified during the cancer transformation.

The simplicity of the method of the invention, which requires very little sample preparation, and a very reliable analysis by EA-IRMS constitute assets for the reproducibility of the measurements, and also for the suitable use of this method in the biological and clinical research field.

The method of the invention also operates more ecologically than biochips do, since said operating does not require the use of chemical products. In the case of biochips, the use of extraction buffers (sodium dodecyl sulfate, mercaptoethanol and other detergents, etc.) and of labeling which is sometimes radioactive or fluorescent are often harmful to the handler. Biochips are disposable, thereby producing waste.

The invention is also directed toward the use of the method defined above, for distinguishing a cell type and/or subtypes, identifying the diseased or healthy condition of the cells studied, determining the biological disruptions linked to the measurements carried out, and/or evaluating the effectiveness of a therapeutic action and/or for constituting a database serving as a reference for identifying the type and the stage of the disease and thus allowing suitable treatment thereof.

These databases also come within the field of the invention. They are characterized in that they contain the data relating to the isotopic fingerprints as established according to the method defined above for various cell types and tissues, in particular cancer cell types and cancerous tissues.

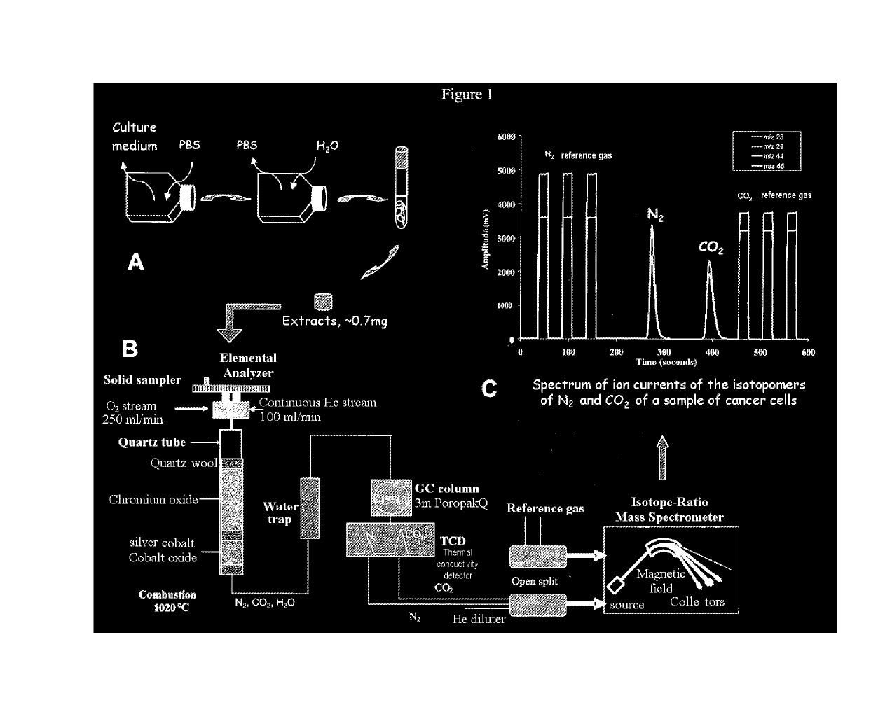

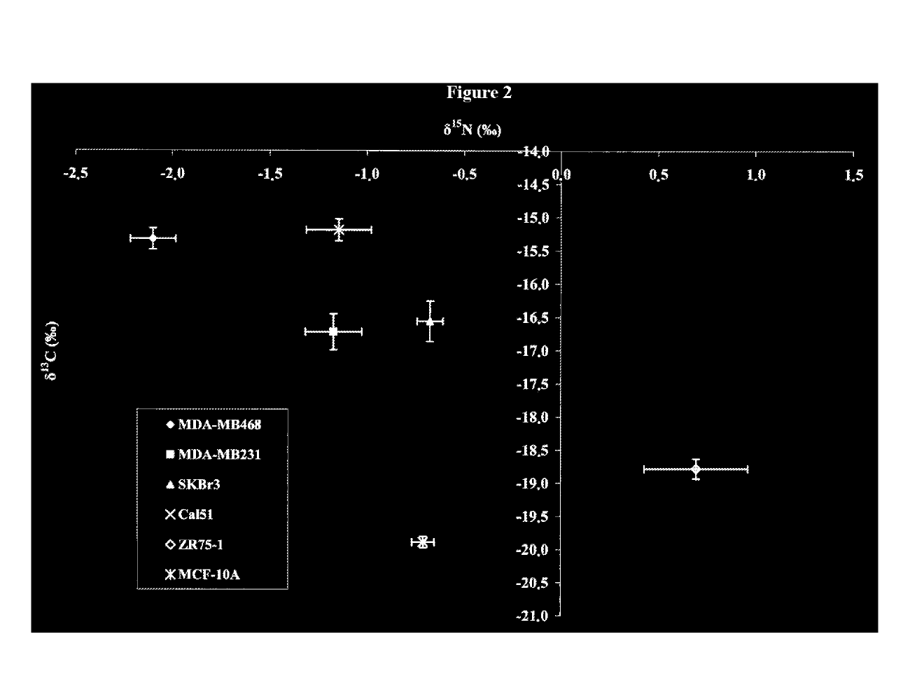

Other characteristics and advantages of the invention are given in the examples which follow and are illustrated via the results given in FIGS. 1 and 2, which represent respectively the method of the invention:

FIG. 1, the diagrammatic description of the steps of the method of the invention, making it possible to obtain the natural abundance of the isotopes of nitrogen 15 and of carbon 13, for example, in cancer cells and

FIG. 2, the values of the isotopic deviations δ¹⁵N and δ¹³C of the cells of various lines using EA-IRMS.

### EXAMPLE 1

### Study of Human Breast Cancer Cell Lines

The cell lines studied are the MDA MB-468, MDA MB-231, SkBr3, Cal 51, ZR 75-1 and MCF-10A lines and are described in table I.

TABLE I
Characteristics of the breast cancer lines
studied. The name and numbering used by the ATCC
(American Type Culture Collection) are given for each
line. The signs + and − reflect the presence and the
absence of the receptors corresponding to estrogen
receptors (ER), progesterone receptors (PR) and to one
of the members of the receptor tyrosine kinases (ErbB),
called HER2.

| Cell | | | | | |
|---|---|---|---|---|---|
| lines | ATCC No. | ER | PR | HER2 | Pathology |
| MDA-MB468 | HTB-132 | − | − | − | adenocarcinoma |
| | | | | | metastasis |
| MDA-MB231 | HTB-26 | − | − | + | adenocarcinoma |
| | | | | | metastasis |
| SKBr3 | HTB-30 | − | − | ++ | adenocarcinoma |
| Cal51 | DSZM- | − | − | − | adenocarcinoma |
| | ACC302 | | | | |
| ZR75-1 | CRL-1500 | + | − | − | invasive ductal |
| | | | | | carcinoma |
| MCF-10A | CRL-10317 | − | − | − | fibrocystic |
| | | | | | disease (non |
| | | | | | cancerous) |

All the cell lines are cultured in 15 ml of nutritive culture medium in a flask with a surface area of 75 cm².

For all the cell lines, except for the MCF-10A line, the medium contains DMEM (Dulbecco's Modified Eagle Medium) supplemented with 10% of fetal bovine serum (FBS) and 1% penicillin-streptomycin (Invitrogen).

For the cells of the MCF-10A line, the medium used is DMEM F12 (Invitrogen) containing 5% of horse serum, 20 ng/ml of EGF (epidermal growth factor), 2 mg/ml of cholera toxin, 0.01 mg/ml of insulin, 0.5 μg/ml of hydrocortisone, 1% of Glutamax L-glutamine, 1% of penicillin-streptomycin and 1% of Hepes (Sigma products).

The flasks containing the cells are placed in an incubator with controlled humidity and atmosphere (5% CO₂), at a temperature of 37° C. When the cells are confluent (about 2 000 000 cells), the culture medium is removed. The cells are rinsed twice with 5 ml of phosphate buffered saline (PBS) with a pH=7.4 in order to completely remove the nutritive medium. These cells are then recovered and detached using a scraper in 3 ml of distilled water. They are then stored at −20° C. and then lyophilized (FIG. 1A).

Approximately 0.7 mg of cell dry extract is then weighed with a 10⁻⁵ g precision balance (Ohaus Discovery DV215CD, Pine Brook, N.J., USA) in tin capsules (tin capsules for solids “light” 5×9 mm, Thermo Fisher Scientific, Bremen, Germany), so as to allow the analysis in an elemental analyzer (EA; Flash EA 1112HT, Thermo Fisher Scientific, Bremen, Germany) coupled via a conflo interface (Finnigan Conflo III, Thermo Fisher Scientific, Bremen, Germany) to an isotope-ratio mass spectrometer (IRMS; IRMS Delta V Advantage, Thermo Fisher Scientific, Bremen, Germany).

The tin capsule containing the cells is introduced, by virtue of a stream of helium and oxygen, into the combustion furnace of the EA at 1020° C. At this temperature, the tin allows, via its sublimation, a transfer of energy to the cell sample which is very rapidly oxidized. The composition of the combustion furnace (chromium oxide, reduced copper, cobalt oxide and silver cobalt) and the amount of oxygen introduced make it possible to quantitatively convert the cell sample into gases N₂ and CO₂ and H₂O.

The gases pass through an anhydrone (magnesium perchlorate) trap which retains the water.

The N₂ and CO₂ gases are then separated using a chromatograpy column, and then introduced successively into the IRMS (FIG. 1B).

The N₂ and CO₂ produced during the combustion of the sample reach the source of the IRMS where they are ionized by electron impact at 120 eV (electron Volt), under a pressure of 10⁻⁶ mbar.

The molecular ions produced (N₂⁺ and CO₂⁺) are then accelerated via a potential of 3 kV and are projected into a uniform magnetic field. These ions are then deviated by this magnetic field of 0.75 Tesla and are simultaneously collected in collectors (Faraday cages). The Faraday cages are connected to amplifiers and the currents produced are proportional to the respective amount of each species of ions collected.

A spectrum of the ion currents of the isotopomers of N₂ and CO₂ is obtained over the course of 10 minutes (FIG. 1C).

For nitrogen, these are the isotopomers of atomic masses 28, 29 and 30 corresponding respectively to the ¹⁴N¹⁴N, ¹⁴N¹⁵N, and ¹⁵N¹⁵N dinitrogen isotopes.

Similarly, for carbon, the isotopomers of atomic masses 44, 45 and 46 are detected and correspond respectively to the ¹²C¹⁶O₂, ¹³C¹⁶O₂ or ¹²O¹⁷O¹⁶O, and ¹²C¹⁷O₂ carbon dioxide isotopes.

The isotopic content of the sample is expressed by the isotope ratio R of the ion currents, which is the fraction of the heaviest isotope over the lightest isotope, i.e. ¹³C/¹²C and ¹⁵N/¹⁴N.

The use of a reference makes it possible to compare the isotope ratio of the sample with that of the reference and to thus obtain great accuracy of the results which are expressed in the relative scale delta δ(%₀):

δ(%₀)=[(Rₛₐₘₚₗₑ−R_{reference})/R_{reference}]×1000

The international references located in the formula via R_{reference} are the Vienna Pee Dee Belemnite (VPDB) carbonate for δ¹³C (R_{reference}=0.0112372) and atmospheric nitrogen for δ¹⁵N (R_{reference}=0.0036765).

A positive value signifies a higher content of heavier isotope than the reference, i.e. an enrichment; whereas a negative value expresses a lower content of heavy isotope than the reference, i.e. a depletion.

Glutamic acid was used as working standard: its δ¹³C and δ¹⁵N are known and stable, respectively −27.48%₀±0.05 and −4.80%₀±0.08.

Two glutamic acid capsules were placed every 5 samples in order to control any shift of the apparatus during the measurement series.

The linearity of the apparatus is ±0.06%₀; the accuracy is ±0.02%₀ for δ¹³C and for δ¹⁵N (data from Thermo Fisher Scientific).

The data collection process was carried out using the Isodat NT 2.5 acquisition software (Thermo Fisher Scientific, Bremen, Germany) which includes the automatic correction for the fraction ¹⁷O of mass 45 via the Craig correction. The carbon percentage (% C) and nitrogen percentage (% N) values are calculated from the ratio of the area under the curve of the peak of the sample over the peak of the working standard, glutamic acid.

Each cell extract was the subject of two analyses. The result taken into account is the mean of the two measurement results. For each line, the analysis was carried out on 3 to 6 samples of a cell division, in order to have an isotopic value representative of the line.

Statistics

The data were exported from the acquisition software to a Microsoft Excel 2003 spreadsheet, where the means and standard deviations of the δ¹³C and δ¹⁵N of each cell line, having undergone several cell divisions, were calculated.

Results

The results obtained (values of the isotopic deviations δ¹⁵N and δ¹³C and of the nitrogen percentages % N and carbon percentages % C) for the lines studied are given in table II and represented in FIG. 2.

TABLE II
Values of the isotopic deviations (δ¹⁵N and δ¹³C)
and of the nitrogen and carbon percentages (% N and %
C), measured by EA-IRMS, in the samples of cells of various
lines studied, as a function of the number of cell divisions
(NCD) and of the number of days of growth (NDG)

| Cell lines | NCD | NDG | δ¹⁵N(%₀) | δ¹³C/(%₀) | % N | % C |
|---|---|---|---|---|---|---|
| MDA-MB468 | 26 | 2 | −2.06 | −15.56 | 7.36 | 29.45 |
| | 31 | 4 | −2.28 | −15.28 | 8.67 | 33.53 |
| | 36 | 3 | −2.03 | −15.1 | 8.02 | 32.91 |
| | 39 | — | −2.14 | −15.33 | 8.24 | 33.35 |
| | 42 | 4 | −2.15 | −15.26 | 7.77 | 31.7 |
| | 48 | 2 | −1.94 | −15.44 | 7.79 | 31.5 |
| MDA-MB231 | 2 | 2 | −1.16 | −16.59 | 5.21 | 21.69 |
| | 3 | 4 | −0.97 | −17.12 | 5.33 | 24.84 |
| | 5 | 3 | −1.3 | −16.53 | 5.31 | 22.53 |
| | 6 | 4 | −1.25 | −16.65 | 5.67 | 22.72 |
| SKBr3 | 19 | 4 | −0.69 | −16.92 | 5.13 | 22.41 |
| | 20 | 3 | −0.64 | −16.6 | 4.05 | 16.12 |
| | 21 | 3 | −0.62 | −16.02 | 5.06 | 19.94 |
| | 22 | 3 | −0.6 | −16.51 | 4.86 | 19.64 |
| | 27 | 3 | −0.74 | −16.58 | 6.26 | 24.41 |
| | 31 | 3 | −0.76 | −16.74 | 4.01 | 18.76 |
| Cal51 | 3 | 3 | −0.95 | −15.24 | 6.59 | 28.29 |
| | 4 | 2 | −1.14 | −15.42 | 6.25 | 26.79 |
| | 7 | 2 | −1.28 | −15.2 | 7.38 | 29.88 |
| | 6 | 3 | −1.01 | −14.95 | 7.52 | 30.95 |
| | 6 | 3 | −1.34 | −15.15 | 7.29 | 29.16 |
| ZR75-1 | 4 | 3 | 0.99 | −18.96 | 2.36 | 12.92 |
| | 5 | 3 | 0.47 | −18.68 | 1.97 | 11.37 |
| | 6 | 4 | 0.63 | −18.73 | 1.76 | 12.38 |
| MCF-10A | 5 | | −0.75 | −19.83 | 3.5 | 20.16 |
| | 5 | | −0.67 | −19.95 | 3.65 | 20.97 |

The δ¹⁵N and δ¹³C values were measured for each line at various numbers of cell divisions and of days of growth. The standard deviations obtained for each cell line as a function of the number of cell divisions and of the number of days of growth were less than 0.3%₀ for δ¹⁵N and δ¹³C (FIG. 2). These results show the absence of isotopic fractionation (table II) induced during cell growth and the number of cell divisions, which is a prerequisite for being sure that the isotopic discrimination originates only from the cell itself. In the same way, the isotopic contents of the nutritive media used for the growth of each line were measured regularly. They were identical for the nutritive media of the tumor lines (δ¹⁵N=3.98±0.18%₀ and δ¹³C=−12.91±0.13%₀). With regard to the medium used for the growth of the MCF-10A, which is a non-tumor line requiring a particular medium, the isotopic content was also constant, with a δ¹⁵N=2.39%₀±0.10 and a δ¹³C=−19.39%₀±0.01. The results show the absence of isotopic fractionation induced by the culture medium. Under these culture conditions, the results are very satisfactory from the viewpoint of the δ¹⁵N and δ¹³C values obtained on the cells of the various lines, respectively between −2.28 and +0.99%₀ and between −19.95 and −15.1%₀ (FIG. 2).

The δ¹⁵N and δ¹³C values are representative of each line. Indeed, the variation recorded on 6 cell lines, cultured and sampled at different periods, does not exceed 0.3%₀. Likewise, the standard deviations recorded for the nutritive media used for each line are negligible. These results show that the simultaneous isotopic analysis of ¹⁵N and of ¹³C carried out on each line constitutes a signature which is characteristic of the cancer type.

The invention thus provides a simple and inexpensive process for identifying a cell, in particular for differentiating cancerous tumors and evaluating a therapeutic effect on these tumors.

1. A method for characterizing the origin and/or condition of diseased cells and by way of comparison healthy cells, characterized in that it comprises the measurement of natural abundance isotope variations of elements of cells, the contents of which are modified in a situation of disease, using an isotope-ratio mass spectrometer (abbreviated as IRMS), advantageously using an elemental analyzer coupled with an isotope-ratio mass spectrometer (abbreviated as EA-IRMS).

2. The method as claimed in claim 1, characterized in that the isotope variations measured are those of ¹⁵N and ¹³C.

3. The method as claimed in claim 2, characterized by the determination of ¹⁵N/¹⁴N and ¹³C/¹²C isotope ratios.

4. The method as claimed in claim 1, characterized in that it also comprises the measurement of natural abundance isotope variations of ²H and/or of ¹⁸O and/or of ³⁴S.

5. The method as claimed in claim 1, characterized in that it comprises at least one of the following steps:
introduction of the cell extracts with a stream containing oxygen into the combustion furnace of an EA-IRMS for the purposes of oxidation and/or reduction for the quantitative conversion of the cells into gas,
removal of the water formed and separation of the gases,
introduction of the gases into the IRMS in order to produce molecular ions collected in collectors,
establishment of the spectra of the ion currents of the isotopomers of the isotopic elements to be measured,
the isotopic content of the cells studied being expressed by the isotope ratio R of the ion currents of the fraction of the heaviest isotope to the lightest isotope, and, if desired,
the comparison of the values obtained with that of a reference gas being expressed in delta per thousand.

6. The method as claimed in claim 5, characterized in that it also comprises the introduction of the cell extracts into a gas chromatograph, in order to separate the molecules, and then into a combustion and reduction furnace for the quantitative conversion of the cells into gas, and then, after removal of the water, the introduction of the gases into the IRMS.

7. The method as claimed in claim 1, characterized in that it is applied to a cell fraction, in particular a protein fraction.

8. The method as claimed in claim 1, characterized in that it is applied to amino acids and/or to polar metabolites which may be intracellular or extracellular or to cell extracts.

9. The method as claimed in claim 1, characterized in that it is applied to lipids extracted from cells.

10. The method as claimed in claim 1, characterized in that it is applied to extracts of cells originating from a tissue or from a biological medium, such as blood or urine, or to cells of a cell line or directly to tissues, blood or urine.

11. The method as claimed in claim 10, characterized in that said cells or tissues are cancer cells or cancerous tissues.

12. The method as claimed in claim 10, characterized in that said cells or tissues are diseased.

13. The method as claimed in claim 10, characterized in that said cells or tissues are healthy.

14. The use of the method as claimed in claim 1, for distinguishing a cell type and/or subtypes, identifying the diseased or healthy condition of the cells studied, determining the biological disruptions linked to the measurements carried out, and/or evaluating the effectiveness of a therapeutic treatment and/or for constituting a database which serves as a reference for identifying the type and the stage of the disease and thus allowing suitable treatment thereof.
